(19) United States
(12) Patent Application Publication
(10) Pub. No.: US 2021/0081390 A1
(43) Pub. Date: Mar. 18, 2021

(54) SERVER

(71) Applicant: LG ELECTRONICS INC., Seoul (KR)

(72) Inventors: Jihwan PARK, Seoul (KR); Taewoo JOO, Seoul (KR)

(73) Assignee: LG ELECTRONICS INC., Seoul (KR)

(21) Appl. No.: 17/004,821

(22) Filed: Aug. 27, 2020

(30) Foreign Application Priority Data
Aug. 30, 2019 (KR) 10-2019-0107748

(51) Int. Cl. G06F 16/22; G06N 20/00

(52) U.S. Cl. CPC G06F 16/2282; G06N 20/00

(57) ABSTRACT

Provided is a server. The server comprises a communicator configured to receive or transmit data from or to an external source and a processor configured to, through the communicator, receive data from a plurality of factory devices in a factory, to generate big table based on the data from the plurality of factory devices, and to manage the data based on the generated big table. Accordingly, data from the plurality of factory devices in the factory may be efficiently managed and processed.

### CROSS-REFERENCE TO RELATED APPLICATION

This application claims the priority benefit of Korean Patent Application No. 10-2019-0107748, filed on, 30 Aug. 2019 in the Korean Intellectual Property Office, the disclosure of which is incorporated herein by reference.

### BACKGROUND OF THE DISCLOSURE

### 1. Field of the Disclosure

The present disclosure relates to a server, and more particularly, to a server capable of efficiently managing and processing data from a plurality of factory devices of a factory.

### 2. Description of the Related Art

Various factory devices are used in a factory to manufacture products.

For example, various factory devices such as an injection machine, a take-out robot, an automatic inspection machine, and a mold machine in the factory are used.

Meanwhile, to manufacture a final product, if conditions of each of the injection machine, take-out robot, automatic inspection machine, mold machine, and the like proceeds through empirical management, even if some of multiple conditions are changed, there is a difficulty in stabilizing quality of products because change history does not remain. In particular, it is difficult to stabilize quality of products when conditions for injection molding are changed.

Meanwhile, a huge amount of data is generated in real time from various factory devices such as the injection machine or the like, but there is no concept of how to efficiently manage and store the huge amount of data.

### SUMMARY OF THE DISCLOSURE

The present disclosure provides a server capable of efficiently managing and processing data from a plurality of factory devices of a factory.

The present disclosure also provides a server capable of improving a yield at a time of manufacturing a product by managing data from a plurality of factory devices in a factory.

In an aspect, a server comprises: a communicator configured to receive or transmit data from or to an external source; and a processor configured to, through the communicator, receive data from a plurality of factory devices in a factory, to generate a big table based on the data from the plurality of factory devices, and to manage the data based on the generated big table.

The processor may perform learning based on the big table and derive a failure or defect cause factor based on the learning.

The processor may receive only data at the time of outputting a product of each of the plurality of factory devices among the data from the plurality of factory devices.

The processor may generate the big table using the data at the time of outputting a product of each of the plurality of factory devices.

The plurality of factory devices may comprise an injection machine and a take-out robot, and the processor may receive only data corresponding to outputting of a product from the injection machine among the data from the plurality of factory devices.

The data from the plurality of factory devices may comprise operation data and sensor data.

The processor may receive average sensor data of values generated during manufacturing of each of the plurality of factory devices among the sensor data.

The processor may generate the big table based on the operation data and the sensor data from the plurality of factory devices.

The data from the plurality of factory devices may comprise operation data, sensor data, and defect information data.

The processor may generate the big table using the operation data, the sensor data, and the defect information data from each of the plurality of factory devices.

The processor may control each data from the plurality of factory devices in the big table to be connected to each other.

The big table may comprise injection machine data, take-out robot data, inspection data, and defect information data.

When a product is defective, the processor may perform learning using the big table generated based on the data from the plurality of factory devices and derive a failure or defect cause factor based on the learning.

When the injection machine, among the plurality of factory devices, is defective, the processor may perform learning using the big table generated based on the data from the plurality of factory devices and derive a failure or defect cause factor based on the learning.

In another aspect, a server comprises: a communicator configured to receive or transmit data from or to an external source; and a processor configured to, through the communicator, receive data from a plurality of factory devices in a factory, to perform learning based on the data from the plurality of factory devices, and to derive a failure or defect cause factor based on the learning.

The processor may generate a big table based on the data from the plurality of factory devices, perform learning based on the generated big table, and derive a failure or defect cause factor based on the learning.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view showing a factory management system according to an embodiment of the present disclosure;

FIG. 2 is a simplified internal block diagram of a server of FIG. 1;

FIGS. 3A and 3B illustrate various learning algorithms;

FIG. 4 shows an example of an internal block diagram of a processor of FIG. 2;

FIG. 5 is a flowchart illustrating a method of operating a server according to an embodiment of the present disclosure; and

FIGS. 6A to 13F are views referred to for description of an operation method of FIG. 5.

### DETAILED DESCRIPTION OF THE PREFERRED EMBODIMENTS

Hereinafter, the present disclosure will be described in detail with reference to the accompanying drawings.

In the following description, usage of suffixes such as “module”, “part” or “unit” used for referring to elements is given merely to facilitate explanation of the present invention, without having any significant meaning by itself. Therefore, the “module”, “part” or “unit” may be used in combination.

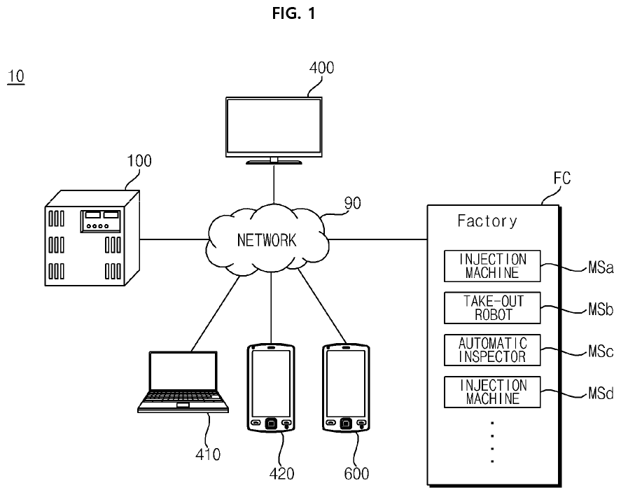

FIG. 1 is a view showing a factory management system according to an embodiment of the present disclosure.

Referring to the drawing, a factory management system 10 of FIG. 1 comprises a video display device 400, a computer 410, a tablet 420, a mobile terminal 600, a server 100 for effectively detecting and monitoring an online issue, and a plurality of factory devices MSa, MSb, MSc, and MSd in a factory FC connected to a network 90.

Meanwhile, the server 100 in the drawing is an example of a device for factory management. Unlike the drawing, a function for factory management may be mounted on various electronic devices (e.g., video display device, computer, mobile terminal, etc.) in addition to the server 100.

Meanwhile, the plurality of factory devices MSa, MSb, MSc, and MSd may output data at predetermined time intervals, respectively.

Here, the data may comprise operation data of each of the plurality of factory devices MSa, MSb, MSc, and MSd.

Meanwhile, the data may comprise operation data and sensor data of each of the plurality of factory devices MSa, MSb, MSc, and MSd.

Meanwhile, the data may comprise operation data, sensor data, and defect information data of each of the plurality of factory devices MSa, MSb, MSc, and MSd.

When a large number of factory devices in the factory FC outputs operation data, sensor data, and defect information data at predetermined time intervals, data management is not easy.

Thus, in the present disclosure, a method for efficiently managing and processing operation data, sensor data, and defect information data output at predetermined time intervals is devised.

To this end, the server 100 according to an embodiment of the present disclosure generates a big table based on data from the plurality of factory devices MSa, MSb, MSc, and MSd, and manage data based on the generated big table.

Accordingly, it is possible to efficiently manage and process the data from the plurality of factory devices MSa, MSb, MSc, and MSd in the factory.

Meanwhile, the server 100 may perform learning based on the big table and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, the server 100 may receive only data at the time of manufacturing a product of each of the plurality of the factory devices among data from the plurality of factory devices MSa, MSb, MSc, and MSd. Accordingly, it is possible to efficiently manage and process the data from the plurality of factory devices MSa, MSb, MSc, and MSd in the factory.

Meanwhile, the server 100 may generate a big table using the data at the time of outputting a product of each of the plurality of factory devices MSa, MSb, MSc, and MSd. Accordingly, it is possible to efficiently manage and process the data from the plurality of factory devices MSa, MSb, MSc, and MSd in the factory.

Meanwhile, the server 100 may receive only data corresponding to outputting a product from an injection machine Msa among the data from the plurality of factory devices MSa, MSb, MSc, and MSd. Accordingly, it is possible to efficiently manage and process the data from the plurality of factory devices MSa, MSb, MSc, and MSd in the factory.

Meanwhile, the data from the plurality of factory devices MSa, MSb, MSc, and MSd may comprise operation data and sensor data. Accordingly, it is possible to efficiently manage and process the data from the plurality of factory devices MSa, MSb, MSc, and MSd in the factory.

Meanwhile, the server 100 may receive average sensor data of values generated during manufacturing a product of each of the plurality of factory devices MSa, MSb, MSc, and MSd among sensor data. Accordingly, it is possible to efficiently manage and process the data from the plurality of factory devices MSa, MSb, MSc, and MSd in the factory.

Meanwhile, the server 100 may generate a big table based on the operation data and sensor data from the plurality of factory devices MSa, MSb, MSc, and MSd. Accordingly, it is possible to efficiently manage and process the data from the plurality of factory devices MSa, MSb, MSc, and MSd in the factory.

Meanwhile, the data from the plurality of factory devices MSa, MSb, MSc, and MSd may comprise operation data, sensor data, and defect information data. Accordingly, it is possible to efficiently manage and process the data from the plurality of factory devices MSa, MSb, MSc, and MSd in the factory.

Meanwhile, the server 100 may generate the big table using each of the operation data, sensor data, and defect information data from the plurality of factory devices MSa, MSb, MSc, and MSd. Accordingly, it is possible to efficiently manage and process the data from the plurality of factory devices MSa, MSb, MSc, and MSd in the factory.

Meanwhile, the server 100 may control each data from the plurality of factory devices MSa, MSb, MSc, and MSd in the big table to be connected to each other. Accordingly, it is possible to efficiently manage and process the data from the plurality of factory devices MSa, MSb, MSc, and MSd in the factory.

Meanwhile, the big table may comprise injection machine data, take-out robot data, inspection data, and defect information data. Accordingly, it is possible to efficiently manage and process the data from the plurality of factory devices MSa, MSb, MSc, and MSd in the factory.

Meanwhile, when a product is defective, the server 100 may perform learning using the big table generated based on the data from the plurality of factory devices MSa, MSb, MSc, and MSd, and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, when the injection machine, among the plurality of factory devices MSa, MSb, MSc, and MSd, is defective, the server 100 may perform learning using the big table generated based on the data from the plurality of factory devices MSa, MSb, MSc, and MSd and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, the server 100 according to another embodiment of the present disclosure may perform learning based on the data from the plurality of factory devices MSa, MSb, MSc, and MSd, and based on the learning and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, the server 100 may generate a big table based on the data from the plurality of factory devices MSa, MSb, MSc, and MSd, performs learning based on the generated big table, and derive a failure or defect cause factor based on the learning. Accordingly, it is possible to improve a yield at the time of manufacturing a product by managing the data from the plurality of factory devices MSa, MSb, MSc, and MSd in the factory.

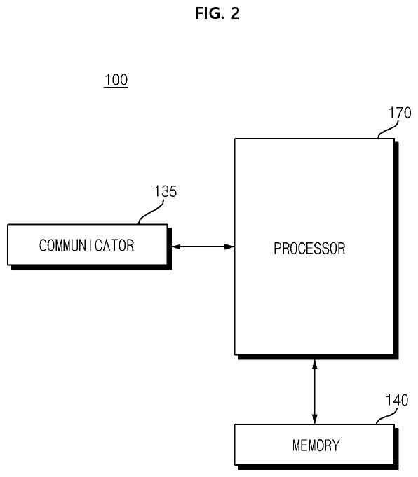

FIG. 2 is a simplified internal block diagram of the server of FIG. 1.

Referring to the drawing, the server 100 may comprise a communicator 135, a processor 170, and a memory 140.

The communicator 135 may receive or transmit data from or to an external network 90.

For example, the communicator 135 may receive data from the plurality of factory devices MSa, MSb, MSc, and MSd.

In this case, the data may comprise operation data of each of the plurality of factory devices MSa, MSb, MSc, and MSd.

Meanwhile, the data may comprise operation data and sensor data of each of the plurality of factory devices MSa, MSb, MSc, and MSd.

Meanwhile, the data may comprise operation data, sensor data, and defect information data of each of the plurality of factory devices MSa, MSb, MSc, and MSd.

The memory 140 may store data necessary for the operation of the server 100.

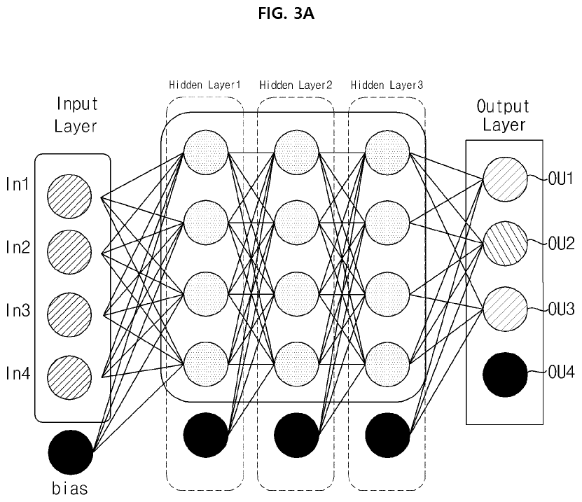

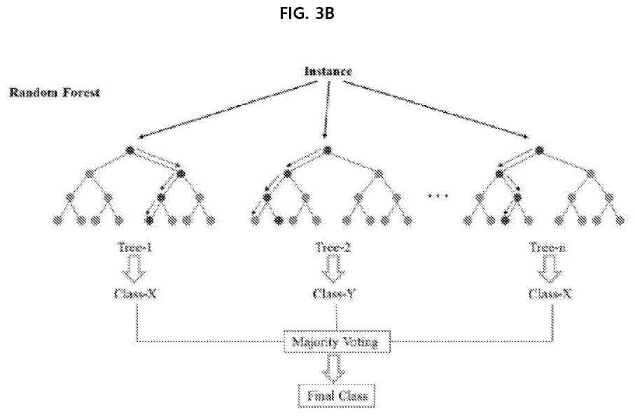

For example, the memory 140 may store a learning algorithm for performing in the server 100. In this case, the learning algorithm may be a learning algorithm based on a deep neural network as shown in FIG. 3A or a RandomForest-based learning algorithm as shown in FIG. 3B.

Meanwhile, the processor 170 may perform overall operation control of the server 100.

Meanwhile, the processor 170 may generate a big table based on the data from the plurality of factory devices MSa, MSb, MSc, and MSd, and manage data based on the generated big table.

Accordingly, it is possible to efficiently manage and process the data from the plurality of factory devices MSa, MSb, MSc, and MSd in the factory.

Meanwhile, the processor 170 may perform learning based on the big table and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, the processor 170 may receive only data at the time of outputting a product of each of the plurality of factory devices MSa, MSb, MSc, and MSd among data from the plurality of factory devices MSa, MSb, MSc, and MSd. Accordingly, it is possible to efficiently manage and process the data from the plurality of factory devices MSa, MSb, MSc, and MSd in the factory.

Meanwhile, the processor 170 may generate a big table using the data at the time of outputting a product of each of the plurality of factory devices MSa, MSb, MSc, and MSd. Accordingly, it is possible to efficiently manage and process the data from the plurality of factory devices MSa, MSb, MSc, and MSd in the factory.

Meanwhile, a plurality of factory devices MSa, MSb, MSc, and MSd may comprise an injection machine Msa and a take-out robot, and the processor 170 may receive only data corresponding to outputting of a product from the injection machine Msa among data from the plurality of factory devices MSa, MSb, MSc, and MSd. Accordingly, it is possible to efficiently manage and process the data from the plurality of factory devices MSa, MSb, MSc, and MSd in the factory.

Meanwhile, the data from the plurality of factory devices MSa, MSb, MSc, and MSd may comprise operation data and sensor data. Accordingly, it is possible to efficiently manage and process the data from the plurality of factory devices MSa, MSb, MSc, and MSd in the factory.

Meanwhile, the processor 170 may receive average sensor data of values generated during manufacturing of each of the plurality of factory devices MSa, MSb, MSc, and MSd among sensor data. Accordingly, it is possible to efficiently manage and process the data from the plurality of factory devices MSa, MSb, MSc, and MSd in the factory.

Meanwhile, the processor 170 may generate a big table based on operation data and sensor data from the plurality of factory devices MSa, MSb, MSc, and MSd. Accordingly, it is possible to efficiently manage and process the data from the plurality of factory devices MSa, MSb, MSc, and MSd in the factory.

Meanwhile, data from a plurality of factory devices MSa, MSb, MSc, and MSd may comprise operation data, sensor data, and defect information data. Accordingly, it is possible to efficiently manage and process the data from the plurality of factory devices MSa, MSb, MSc, and MSd in the factory.

Meanwhile, the processor 170 may generate a big table using the operation data, the sensor data, and the defect information data from each of a plurality of factory devices MSa, MSb, MSc, and MSd. Accordingly, it is possible to efficiently manage and process the data from the plurality of factory devices MSa, MSb, MSc, and MSd in the factory.

Meanwhile, the processor 170 may control each data from a plurality of factory devices MSa, MSb, MSc, and MSd in the big table to be connected to each other. Accordingly, it is possible to efficiently manage and process the data from the plurality of factory devices MSa, MSb, MSc, and MSd in the factory.

Meanwhile, the big table may comprise injection machine (Msa) data, take-out robot data, inspection data, and defect information data. Accordingly, it is possible to efficiently manage and process the data from the plurality of factory devices MSa, MSb, MSc, and MSd in the factory.

Meanwhile, when a product is defective, the processor 170 may perform learning using the big table generated based on the data from the plurality of factory devices MSa, MSb, MSc, and MSd, and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, when the injection machine, among the plurality of factory devices MSa, MSb, MSc, and MSd, is defective, the processor 170 may perform learning using the big table generated based on the data from the plurality of factory devices MSa, MSb, MSc, and MSd and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, the processor 170 may compare a manufactured normal product information with reference product information and derive a cause factor of a defect or error at the time of the defect or error.

Meanwhile, the processor 170 may determine whether a product is abnormal using an automatic inspector MSc.

In particular, when determining whether a product is abnormal, the processor 170 may determine the product by comparing the product with a reference value.

Meanwhile, the processor 170 may also manage data such as a reference value and an allowable value. Also, updating may be performed. Accordingly, an error of the product may be gradually reduced.

Meanwhile, the processor 170 may integratedly manage the data from the plurality of factory devices MSa, MSb, MSc, and MSd and derive a cause when a product is defective or has an error through learning.

Meanwhile, the processor 170 may derive a hidden factor in case of a product defect or error through learning. Also, the processor 170 may control to output the derived hidden factor through an alarm or the like.

Meanwhile, the processor 170 may control the learning algorithm to be updated.

Meanwhile, the processor 170 may select and utilize a learning algorithm having a low error among a plurality of learning algorithms.

Meanwhile, the processor 170 may determine whether sensor data is correct using the automatic inspector MSc. For example, if the sensor data is incorrect, data management may be performed by correcting the incorrect sensor data.

Meanwhile, the processor 170 may perform operation control of the plurality of factory devices MSa, MSb, MSc, and MSd based on the integratedly managed data.

Meanwhile, the processor 170 may provide new information for controlling the operation of the plurality of factory devices MSa, MSb, MSc, and MSd based on the integratedly managed data or generates and outputs new standards.

FIGS. 3A to 3B illustrate various learning algorithms.

First, FIG. 3A illustrates an example of a learning algorithm based on a deep neural network.

Referring to the drawing, the processor 170 may perform leaning to a deep level by multiple stages based on data through a deep learning technology, which is a type of machine learning.

Deep learning may represent a set of machine learning algorithms that extract key data from a plurality of data while sequentially passing through hidden layers.

The deep learning structure may comprise an deep neural network (DNN) such as an artificial neural network (ANN), a convolutional neural network (CNN), a recurrent neural network (RNN), or a deep belief network (DBN).

The deep neural network (DNN) may comprise an input layer, a hidden layer, and an output layer.

Meanwhile, having multiple hidden layers may be referred to as a deep neural network (DNN).

Each layer may comprise a plurality of nodes, and each layer may be associated with a next layer. Nodes may be connected to each other with a weight.

An output from a certain node belonging to a first hidden layer (Hidden Layer 1) is an input of at least one node belonging to a second hidden layer (Hidden Layer 2). Here, the input of each node may be a value obtained by applying a weight to an output of a node of a previous layer. Weight may refer to a connection strength between nodes. The deep learning process may also be seen as a process of finding an appropriate weight.

FIG. 3B illustrates an example of a RandomForest-based learning algorithm.

Referring to the drawing, random forest is an algorithm created using a decision tree. Random forest is a kind of ensemble learning method used for classification and regression analysis and operates by outputting classification or average prediction values from a number of decision trees constructed in a training process. In other words, random forest is a method of making multiple decision trees and voting to determine a result by majority.

Although there are several tens of tree nodes in FIG. 3B, in fact, hundreds to tens of thousands of nodes may be generated. It may be voted through multiple trees to prepare for overfitting.

Meanwhile, in order to acquire a random tree, a forest is constructed by bootstrapping data in the random forest.

It is called bootstrap aggregating or begging, and learning is performed by inputting a result of a sample as an input value of each tree, rather than using all data.

This produces randomness because each tree is constructed with different data. Also, randomness is given to a variable, when partitioning. That is, rather than selecting an optimal variable among all the remaining variables, only some of the variables are selected and an optimal variable is selected from among the some. This method may be referred to as ensemble learning.

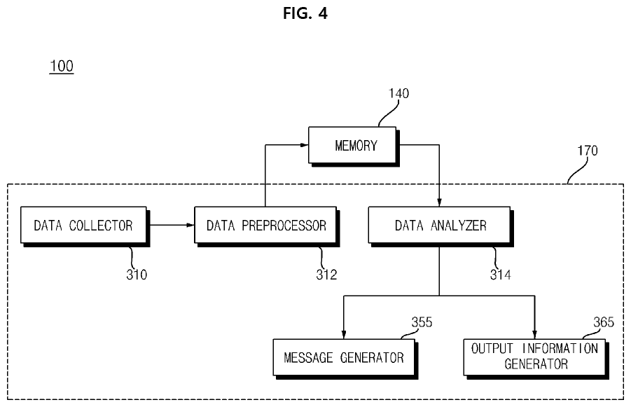

FIG. 4 is an example of an internal block diagram of the processor of FIG. 2.

Referring to FIG. 4, the processor 170 of FIG. 2 may comprise a data collector 310, a data preprocessor 312, a data analyzer 314, a message generator 355, and an output information generator 365.

The data collector 310 may receive data from the plurality of factory devices MSa, MSb, MSc, and MSd through the communicator 135.

In this case, the data may comprise operation data of each of the plurality of factory devices MSa, MSb, MSc, and MSd.

Meanwhile, the data may comprise operation data and sensor data of each of the plurality of factory devices MSa, MSb, MSc, and MSd.

Meanwhile, the data may comprise operation data, sensor data, and defect information data of each of the plurality of factory devices MSa, MSb, MSc, and MSd.

Meanwhile, the data preprocessor 312 may receive only data at the time of outputting a product of each of the plurality of factory devices MSa, MSb, MSc, and MSd among data from the plurality of factory devices MSa, MSb, MSc, and MSd. Accordingly, it is possible to efficiently manage and process the data from the plurality of factory devices MSa, MSb, MSc, and MSd in the factory.

Meanwhile, the data preprocessor 312 may receive only data corresponding to outputting of a product from the injection machine Msa among the data from the plurality of factory devices MSa, MSb, MSc, and MSd. Accordingly, it is possible to efficiently manage and process the data from the plurality of factory devices MSa, MSb, MSc, and MSd in the factory.

Meanwhile, the data preprocessor 312 may receive average sensor data of values generated during the manufacturing of each of the plurality of factory devices MSa, MSb, MSc, and MSd among the sensor data. Accordingly, it is possible to efficiently manage and process the data from the plurality of factory devices MSa, MSb, MSc, and MSd in the factory.

Meanwhile, the data analyzer 314 may generate a big table based on the data from the plurality of factory devices MSa, MSb, MSc, and MSd, and manage the data based on the generated big table.

Meanwhile, the data analyzer 314 may generate the big table based on the data from the plurality of factory devices MSa, MSb, MSc, and MSd and manage the data based on the generated big table. Accordingly, it is possible to efficiently manage and process the data from the plurality of factory devices MSa, MSb, MSc, and MSd in the factory.

Meanwhile, the data analyzer 314 may perform learning based on the big table and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, the data analyzer 314 may generate a big table using data at the time of outputting a product of each of the plurality of factory devices MSa, MSb, MSc, and MSd. Accordingly, it is possible to efficiently manage and process the data from the plurality of factory devices MSa, MSb, MSc, and MSd in the factory.

Meanwhile, the data analyzer 314 may generate a big table based on operation data and sensor data from the plurality of factory devices MSa, MSb, MSc, and MSd. Accordingly, it is possible to efficiently manage and process the data from the plurality of factory devices MSa, MSb, MSc, and MSd in the factory.

Meanwhile, the data analyzer 314 may generate a big table using each of operation data, sensor data, and defect information data from the plurality of factory devices MSa, MSb, MSc, and MSd. Accordingly, it is possible to efficiently manage and process the data from the plurality of factory devices MSa, MSb, MSc, and MSd in the factory.

Meanwhile, the data analyzer 314 may control each data from a plurality of factory devices MSa, MSb, MSc, and MSd in the big table to be connected to each other. Accordingly, it is possible to efficiently manage and process the data from the plurality of factory devices MSa, MSb, MSc, and MSd in the factory.

Meanwhile, the big table may comprise injection machine (Msa) data, take-out robot data, inspection data, and defect information data. Accordingly, it is possible to efficiently manage and process the data from the plurality of factory devices MSa, MSb, MSc, and MSd in the factory.

Meanwhile, when a product is defective, the data analyzer 314 may perform learning using the big table generated based on the data from the plurality of factory devices MSa, MSb, MSc, and MSd, and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, when the injection machine, among the plurality of factory devices MSa, MSb, MSc, and MSd, is defective, the data analyzer 314 may perform learning using the big table generated based on the data from the plurality of factory devices MSa, MSb, MSc, and MSd and derive a failure or defect cause factor based on the learning. Accordingly, it is possible to improve a yield at the time of manufacturing a product by managing the data from the plurality of factory devices MSa, MSb, MSc, and MSd in the factory.

Meanwhile, the data analyzer 314 may compare a manufactured normal product information with reference product information and derive a cause factor of a defect or error at the time of the defect or error.

Meanwhile, the data analyzer 314 may determine whether or not a product is abnormal using an automatic inspector MSc.

Meanwhile, when determining whether a product is abnormal, the data analyzer 314 may determine the product by comparing the product with a reference value.

Meanwhile, the data analyzer 314 may also manage data such as a reference value and an allowable value. Also, updating may be performed. Accordingly, an error of the product may be gradually reduced.

Meanwhile, the data analyzer 314 may integratedly manage the data from the plurality of factory devices MSa, MSb, MSc, and MSd and derive a cause when a product is defective or has an error through learning.

Meanwhile, the data analyzer 314 may derive a hidden factor in case of a product defect or error through learning. Also, the processor 170 may control to output the derived hidden factor through an alarm or the like.

Meanwhile, the data analyzer 314 may control the learning algorithm to be updated.

Meanwhile, the data analyzer 314 may select and utilize a learning algorithm having a low error among a plurality of learning algorithms.

Meanwhile, the data analyzer 314 may determine whether sensor data is correct using the automatic inspector MSc. For example, if the sensor data is incorrect, data management may be performed by correcting the incorrect sensor data.

Meanwhile, the data analyzer 314 may perform operation control of the plurality of factory devices MSa, MSb, MSc, and MSd based on the integratedly managed data.

The message generator 355 may generate a message.

Meanwhile, the message generator 355 may provide a message for controlling the operation of the plurality of factory devices MSa, MSb, MSc, and MSd, based on the integratedly managed data.

The output information generator 365 may generate output information.

Meanwhile, the output information generator 365 may provide new information for controlling the operation of the plurality of factory devices MSa, MSb, MSc, and MSd based on the integratedly managed data or may set and output new standards.

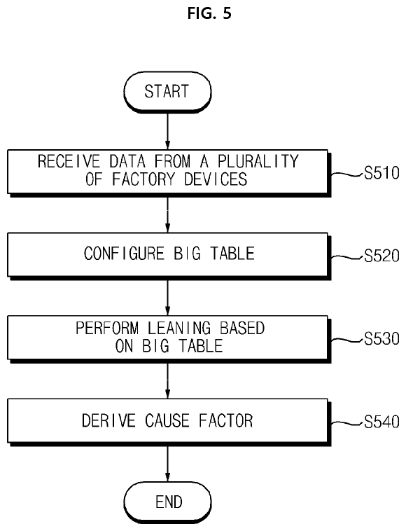

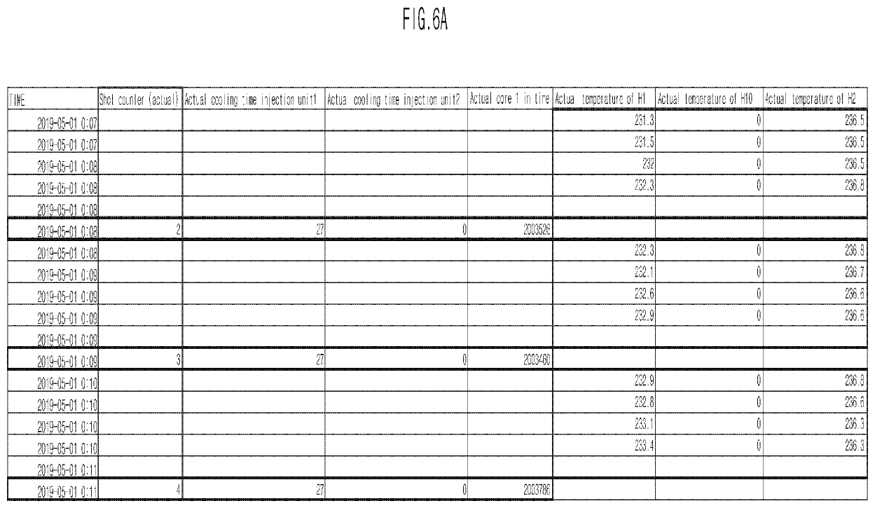

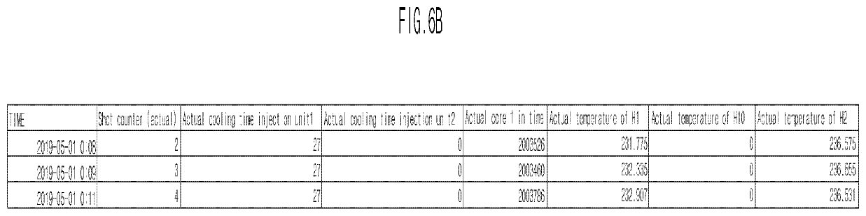

FIG. 5 is a flowchart illustrating an operation method of a server according to an embodiment of the present disclosure, and FIGS. 6A to 13F are diagrams referred to for description of the operation method of FIG. 5.

First, referring to FIG. 5, the server 100 according to an embodiment of the present disclosure receives data from a plurality of factory devices MSa, MSb, MSc, and MSd (S510).

Next, the server 100 constructs a big table based on data from a plurality of factory devices MSa, MSb, MSc, and MSd (S520).

Next, the server 100 performs learning based on the big table (S530).

Next, the server 100 derives a cause factor in case of a defect or an error (S540).

FIG. 6A illustrates an example of data before data preprocessing of the injection machine MSa.

In the drawing, it is illustrated that when three products are manufactured, 18 lines of data are generated as shown.

Meanwhile, data of the injection machine of FIG. 6A comprises operation data and temperature data generated while the products are being manufactured, respectively.

As shown in FIG. 6A, as the amount of data increases, it is difficult to manage the data, and thus, in the present disclosure, the amount of data is reduced through the data preprocessor 312 in the processor 170.

FIG. 6B illustrates an example of data after the data preprocessing of the injection machine MSa.

Referring to the drawing, only three lines of data corresponding to three actually manufactured product data need to be collected and stored. Therefore, a data storage rate is reduced by 83%, compared to FIG. 6A. Meanwhile, it is preferable that the plurality of temperature data in FIG. 6A is converted into average values and stored as shown in FIG. 6B.

That is, the processor 170 may control to store average sensor data of values generated during manufacturing of each of the plurality of factory devices MSa, MSb, MSc, and MSd among sensor data.

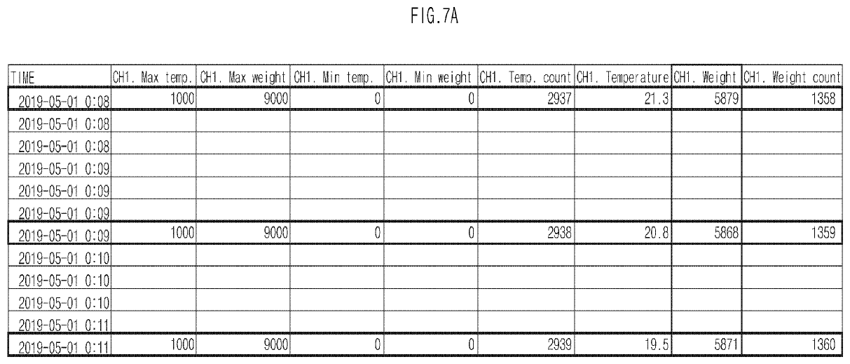

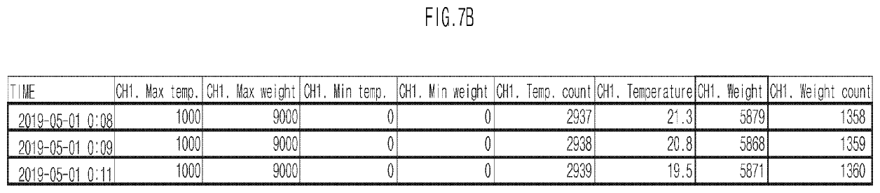

FIG. 7A illustrates another example of data before data preprocessing of the injection machine MSa.

In the drawing, it is illustrated that data of 12 lines is generated when three products are manufactured.

Meanwhile, the data of the injection machine of FIG. 7A comprises operation data and weight data while the product is being manufactured, respectively.

As shown in FIG. 7A, as the amount of data increases, it is difficult to manage the data, and thus, in the present disclosure, the amount of data is reduced through the data preprocessor 312 in the processor 170.

FIG. 7B illustrates another example of data after data preprocessing of the injection machine MSa.

Referring to the drawing, data of only three lines corresponding to three actually manufactured product data need to be collected and stored. Therefore, the data storage rate is reduced by 75%, compared to FIG. 7A.

Meanwhile, it is preferable that the plurality of weight data in FIG. 7A is converted into average values and stored as shown in FIG. 7B.

That is, the processor 170 may control to store the average sensor data of the values generated during the manufacturing of each of the plurality of factory devices MSa, MSb, MSc, and MSd among the sensor data.

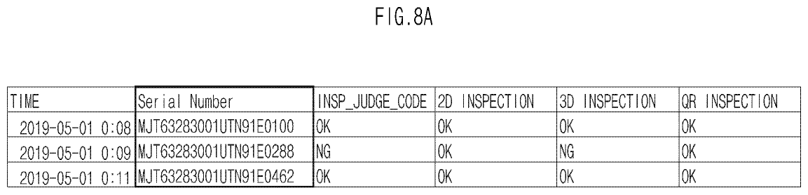

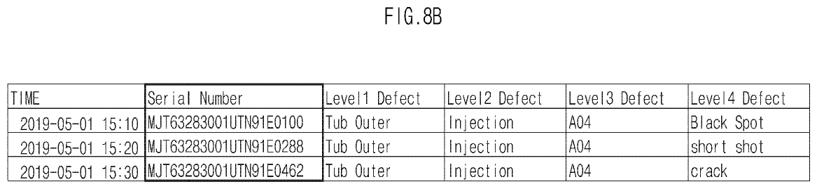

FIG. 8A illustrates an example of data of the inspector MSc.

Referring to the drawing, the data of the inspector MSc comprises a serial number for identifying an individual product. The serial number may be marked on the product by a laser marking machine and may be scanned by a scanner.

Meanwhile, data of the inspector MSc may be sequentially generated.

FIG. 8B illustrates an example of defective information data.

When defective information data of defects generated in a final inspection step through the inspector (MSc) are input in the serial number unit, it is possible to track which defects have occurred in individual product units.

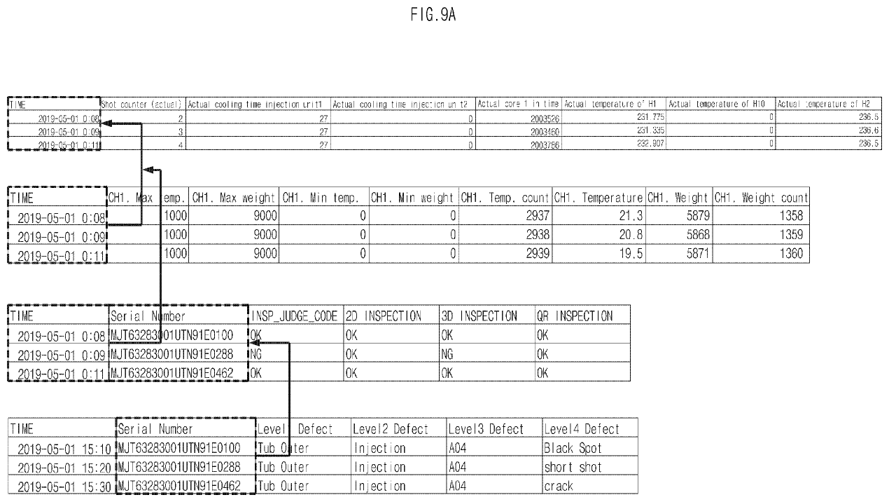

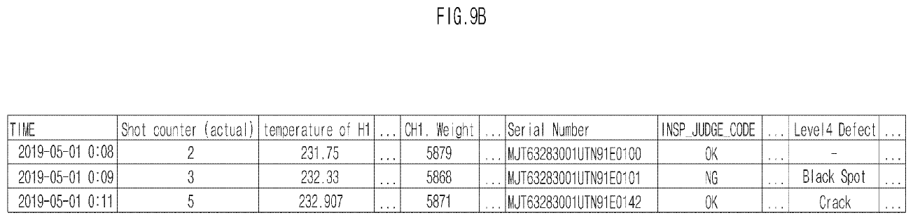

FIG. 9A illustrates injection machine data, robot data, inspection data, and defect information data from top to bottom.

In particular, it is illustrated that the injection machine data, the robot data, the inspection data, and the defect information data are connected by joint keys or the like.

Accordingly, a big table may be configured as shown in FIG. 9B.

FIG. 9B illustrates a big table in which injection machine data, robot data, inspection data, and defect information data are combined.

To this end, the processor 170 preprocesses data with preprocessing rules suitable for the characteristics of each factory device MSa, MSb, MSc, and MSd, and configure a big table with the preprocessed injection machine data, robot data, inspection data, and defect information data using joint keys or the like. Accordingly, it is possible to efficiently manage and process the data from the plurality of factory devices MSa, MSb, MSc, and MSd in the factory.

Meanwhile, the processor 170 may compare and analyze the current data based on the big table and the reference data.

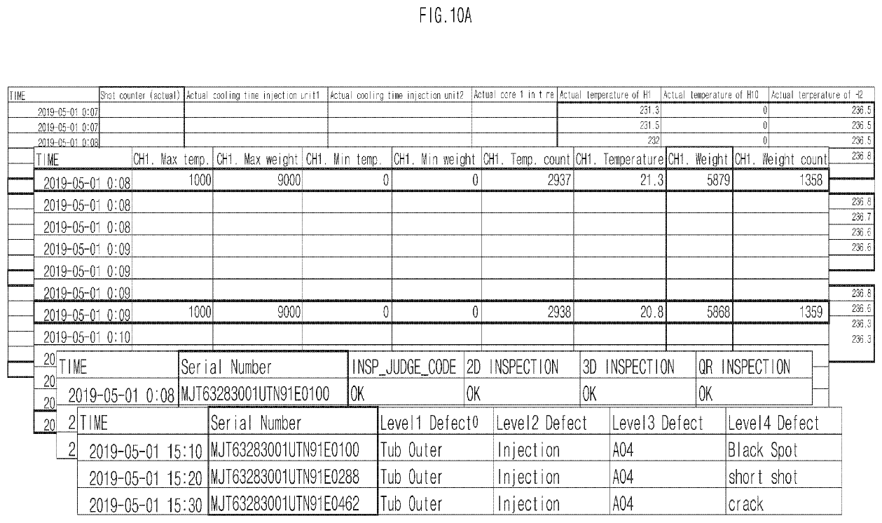

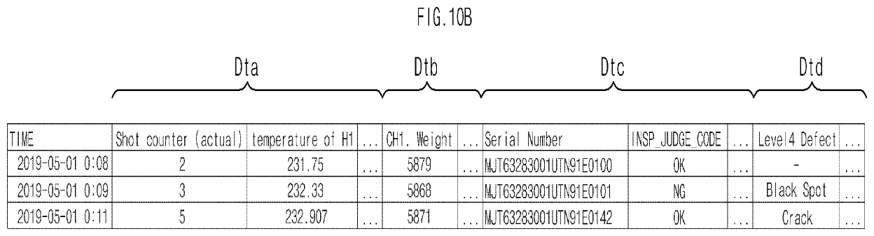

FIG. 10A is a diagram illustrating a comparative analysis of current data based on a big table and reference data.

Also, after the comparative analysis of the current data based on the big table and the reference data, the processor 170 may configure a big table including the comparative analysis data as shown in FIG. 10B.

FIG. 10B shows an example of a big table including comparative analysis data.

The big table including the comparative analysis data in the drawing may comprise injection machine data Dta, robot data Dtb, inspection data Dtc, and defect information data Dtd and comprise comparative analysis data by time.

According to this, it is possible to recognize at a time the injection machine data Dta, robot data Dtb, inspection data Dtc, and defect information data Dtd at the time of manufacturing of a specific product (Serial Number) where a defect occurred.

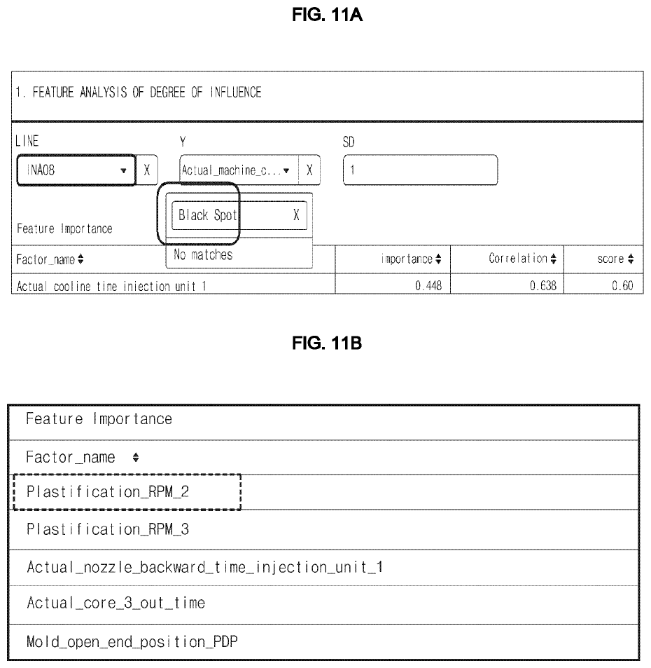

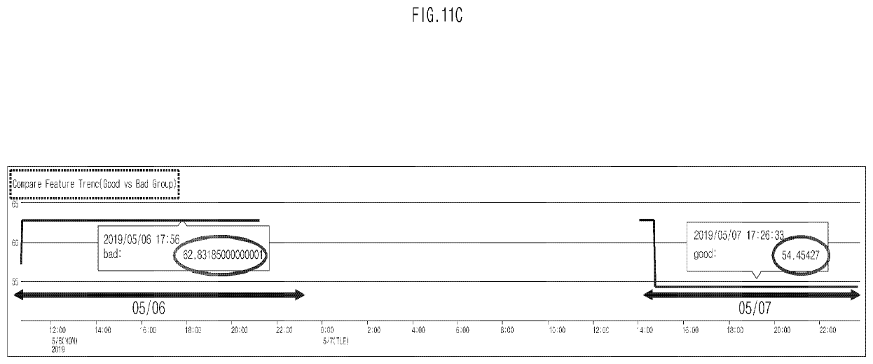

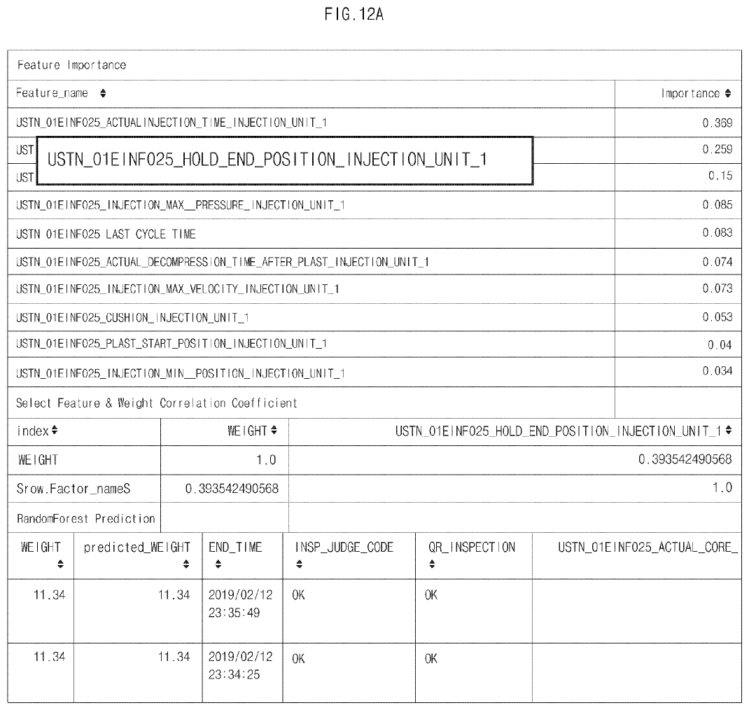

FIG. 11A illustrates a screen for selecting a factory device for analysis and inputting a defect cause to be analyzed.

In the drawing, a “black spot” is illustrated as an input of a defect cause.

Accordingly, the processor 170 performs machine-based learning based on the selected factory device and the defect cause.

In particular, the processor 170 performs a machine learning algorithm using the data of the previously configured big table.

Accordingly, as illustrated in FIG. 11B, the processor 170 may derive cause factors of the “black spot”, which is a defect cause, according to priority.

FIG. 11B illustrates that a factor of Plastification RPM2 is comprised.

The processor 170 may provide information on the derived factor, as shown in FIG. 11C.

FIG. 11C illustrates that the factor of Plastification RPM2 is changed on May 6.

Accordingly, the processor 170 may output a related result to the outside.

FIG. 11C illustrates that a setting value for Plastification RPM2 is corrected to about 54 instead of about according to the derived factor. Accordingly, it is possible to improve a product manufacturing yield.

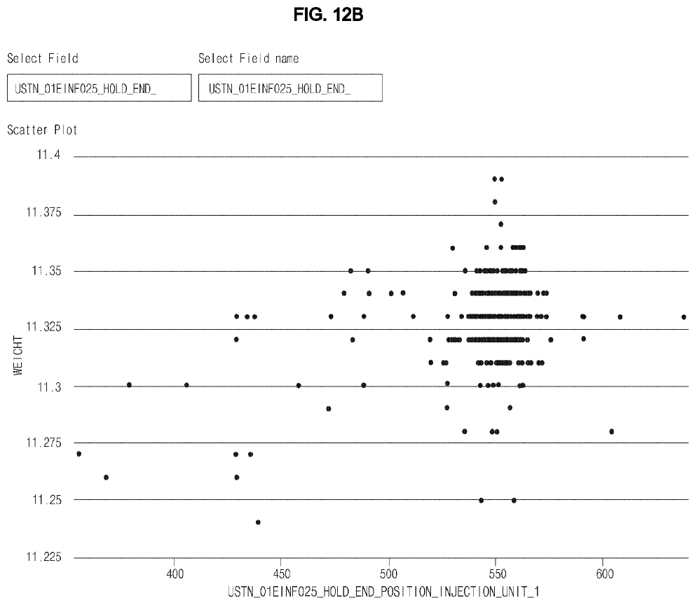

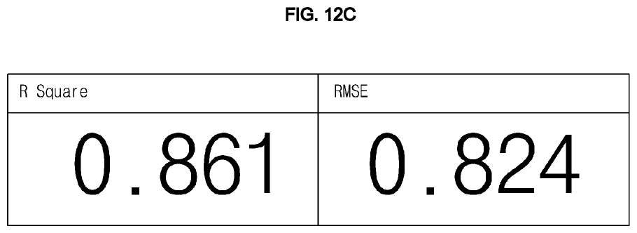

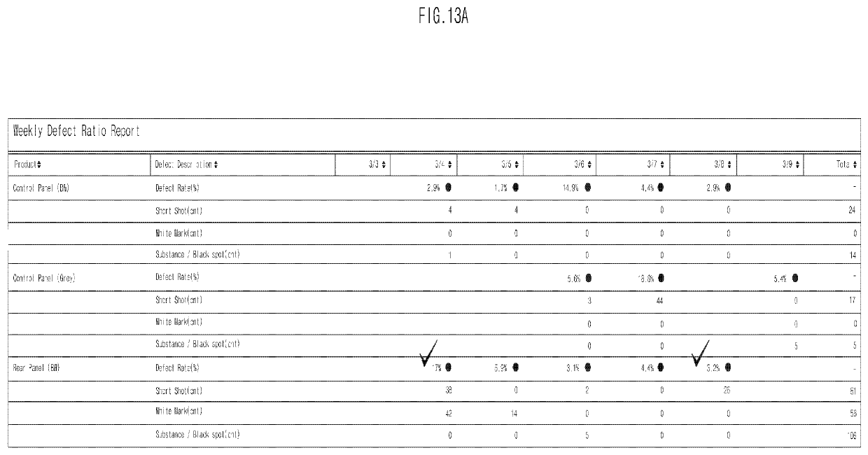

FIG. 12A illustrates factors related to low injection weight during injection of the injection machine.

When a HOLD_END_POSITION value is selected from among a plurality of factors, a scatter plot as shown in FIG. 12B may be illustrated.

According to FIG. 12B, a tendency of low weight may appear as the HOLD_END_POSITION value deviates from a distribution of a steady state to a lower limit value.

Meanwhile, FIG. 12C illustrates an explanatory power and an error level of a model derived through machine learning.

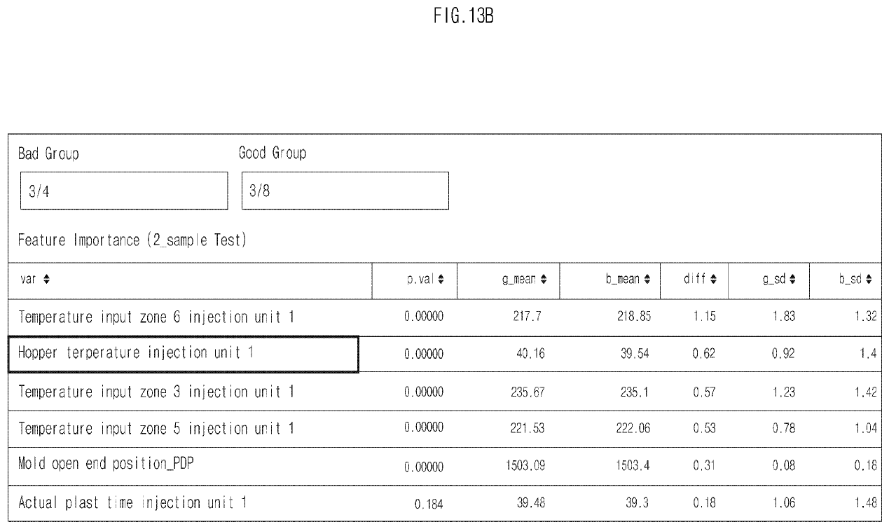

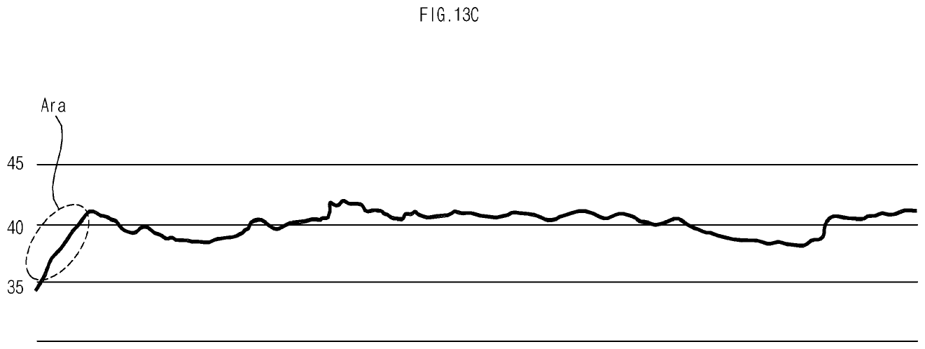

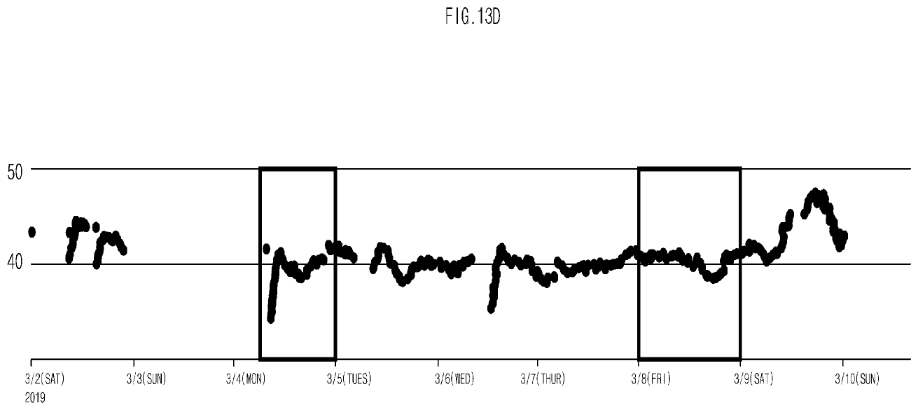

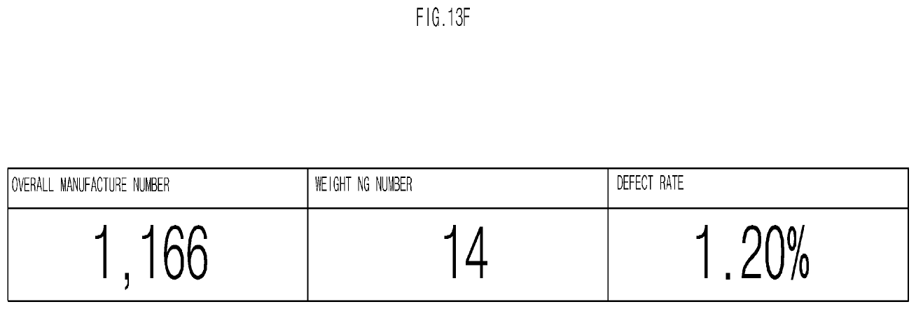

FIG. 13A illustrates an example of a report for each weekly manufactured product.

In the drawing, it is illustrated that defect rates of a rear panel are highlighted on specific dates (March 4 and March 8).

In particular, FIG. 13A may be a report for each weekly manufactured product related to an injection low yield.

FIG. 13B illustrates a plurality of factors related to an injection low yield.

Here, it is illustrated that a value of Hopper temperature injection unit 1 is selected from among a plurality of factors.

FIG. 13C illustrates a trend change curve of Hopper temperature injection unit 1 factor.

In particular, it is illustrated that the Hopper temperature injection unit 1 factor is not stabilized in an Ara region corresponding to March 4.

That is, the Ara region corresponds to a section in which the Hopper temperature injection unit 1 value is not stabilized after manufacturing starts.

Meanwhile, when a rear panel manufacturing history is not collected, the processor 170 may derive factors through a method of estimating a process management standard by checking a trend change for the low yield allegation factor.

FIG. 13D is a view showing a low yield group and a control group. Arb may represent a low yield group, and Arc may represent a control group.

FIG. 13F illustrates an overall manufacture quantity, weighting quantity, and defect rate information. Accordingly, it is possible to easily check defect rate information and the like.

The server according to an embodiment of the present disclosure comprises: a communicator configured to receive or transmit data from or to an external source; and a processor configured to receive data from a plurality of factory devices in a factory through the communicator, to generate big table based on the data from the plurality of factory devices, and to manage the data based on the generated big table. Accordingly, it is possible to efficiently manage and process the data from the plurality of factory devices in the factory.

Meanwhile, the processor may perform learning based on the big table and derive a failure or defect cause factor based on the learning. Accordingly, it is possible to improve a yield at the time of manufacturing a product by managing data from the plurality of factory devices in the factory.

Meanwhile, the processor may receive only data at the time of outputting a product of each of the plurality of factory devices among the data from the plurality of factory devices. Accordingly, it is possible to efficiently manage and process the data from the plurality of factory devices in the factory.

Meanwhile, the processor generate the big table using the data at the time of outputting a product of each of the plurality of factory devices. Accordingly, it is possible to efficiently manage and process the data from the plurality of factory devices in the factory.

Meanwhile, the plurality of factory devices may comprise an injection machine and a take-out robot, and the processor may receive only data corresponding to outputting of a product from the injection machine among data from the plurality of factory devices. Accordingly, it is possible to efficiently manage and process the data from the plurality of factory devices in the factory.

Meanwhile, the data from the plurality of factory devices may comprise operation data and sensor data. Accordingly, it is possible to efficiently manage and process the data from the plurality of factory devices in the factory.

Meanwhile, the processor may receive average sensor data of values generated during manufacturing of each of the plurality of factory devices among the sensor data. Accordingly, it is possible to efficiently manage and process the data from the plurality of factory devices in the factory.

Meanwhile, the processor may generate the big table based on the operation data and the sensor data from the plurality of factory devices. Accordingly, it is possible to efficiently manage and process the data from the plurality of factory devices in the factory.

Meanwhile, the data from the plurality of factory devices may comprise operation data, sensor data, and defect information data. Accordingly, it is possible to efficiently manage and process the data from the plurality of factory devices in the factory.

Meanwhile, the processor may generate the big table using the operation data, the sensor data, and the defect information data from each of the plurality of factory devices. Accordingly, it is possible to efficiently manage and process the data from the plurality of factory devices in the factory.

Meanwhile, the processor may control each data from the plurality of factory devices in the big table to be connected to each other. Accordingly, it is possible to efficiently manage and process the data from the plurality of factory devices in the factory.

Meanwhile, the big table big table may comprise injection machine data, take-out robot data, inspection data, and defect information data. Accordingly, it is possible to efficiently manage and process the data from the plurality of factory devices in the factory.

Meanwhile, when a product is defective, the processor may perform learning using the big table generated based on the data from the plurality of factory devices and derive a failure or defect cause factor based on the learning. Accordingly, it is possible to improve a yield at the time of manufacturing a product by managing the data from the plurality of factory devices in the factory.

Meanwhile, when the injection machine, among the plurality of factory devices, is defective, the processor may perform learning using the big table generated based on the data from the plurality of factory devices and derive a failure or defect cause factor based on the learning. Accordingly, it is possible to improve a yield at the time of manufacturing a product by managing the data from the plurality of factory devices in the factory.

Meanwhile, the server according to another embodiment of the present disclosure comprises a communicator configured to receive or transmit data from or to an external source and a processor configured to receive data from a plurality of factory devices in a factory through the communicator, to perform learning based on the data from the plurality of factory devices, and to derive a failure or defect cause factor based on the learning. Accordingly, it is possible to improve a yield at the time of manufacturing a product by managing the data from the plurality of factory devices in the factory.

Meanwhile, the processor may generate a big table based on the data from the plurality of factory devices, perform learning based on the generated big table, and derive a failure or defect cause factor based on the learning. Accordingly, it is possible to improve the yield at the time of manufacturing a product by managing the data from the plurality of factory devices in the factory.

With the server described above, the configuration of the embodiments described above is not limited in its application, but all or some of the embodiments may be selectively combined to be configured to make various modifications.

Specific embodiments have been described but the present disclosure is not limited to the specific embodiments and various modifications may be made without departing from the scope of the present invention claimed in the claims, and such modifications should not be individually understood from technical concepts or prospects of the present disclosure

What is claimed is:

1. A server comprising:
a communicator configured to receive or transmit data from or to an external source; and
a processor configured to, through the communicator, receive data from a plurality of factory devices in a factory, to generate a big table based on the data from the plurality of factory devices, and to manage the data based on the generated big table.

2. The server of claim 1, wherein the processor performs learning based on the big table and derives a failure or defect cause factor based on the learning.

3. The server of claim 1, wherein the processor receives only data at the time of outputting a product of each of the plurality of factory devices among the data from the plurality of factory devices.

4. The server of claim 3, wherein the processor generates the big table using the data at the time of outputting a product of each of the plurality of factory devices.

5. The server of claim 1, wherein the plurality of factory devices comprise an injection machine and a take-out robot, and the processor receives only data corresponding to outputting of a product from the injection machine among the data from the plurality of factory devices.

6. The server of claim 1, wherein the data from the plurality of factory devices comprise operation data and sensor data.

7. The server of claim 6, wherein the processor receives average sensor data of values generated during manufacturing of each of the plurality of factory devices among the sensor data.

8. The server of claim 6, wherein the processor generates the big table based on the operation data and the sensor data from the plurality of factory devices.

9. The server of claim 1, wherein the data from the plurality of factory devices comprise operation data, sensor data, and defect information data.

10. The server of claim 9, wherein the processor generates the big table using the operation data, the sensor data, and the defect information data from each of the plurality of factory devices.

11. The server of claim 10, wherein the processor controls each data from the plurality of factory devices in the big table to be connected to each other.

12. The server of claim 1, wherein the big table comprises injection machine data, take-out robot data, inspection data, and defect information data.

13. The server of claim 1, wherein when a product is defective, the processor performs learning using the big table generated based on the data from the plurality of factory devices and derives a failure or defect cause factor based on the learning.

14. The server of claim 1, wherein when the injection machine, among the plurality of factory devices, is defective, the processor performs learning using the big table generated based on the data from the plurality of factory devices and derives a failure or defect cause factor based on the learning.

15. A server comprising:
a communicator configured to receive or transmit data from or to an external source; and
a processor configured to, through the communicator, receive data from a plurality of factory devices in a factory, to perform learning based on the data from the plurality of factory devices, and to derive a failure or defect cause factor based on the learning.

16. The server of claim 15, wherein the processor generates a big table based on the data from the plurality of factory devices, performs learning based on the generated big table, and derives a failure or defect cause factor based on the learning.
